(19) United States
(12) Patent Application Publication
(10) Pub. No.: US 2022/0267988 A1
(43) Pub. Date: Aug. 25, 2022

(54) AN EXCAVATOR HAVING A LIFTING DEVICE FOR LIFTING A PALLET

(71) Applicant: James RUSSELL, Larne (GB)

(72) Inventor: James RUSSELL, Larne (GB)

(21) Appl. No.: 17/627,744

(22) PCT Filed: Jul. 16, 2020
(86) PCT No.: PCT/EP2020/070139

§ 371 Date: Jan. 17, 2022

(30) Foreign Application Priority Data
Jul. 18, 2019 (GB) 1910310.0

(51) Int. Cl. E02F 3/96; B66F 9/08

(52) U.S. Cl. CPC E02F 3/963; B66F 9/08

(57) ABSTRACT

An excavator (1) having a lifting device (2) for lifting a pallet comprising a chassis (3) having a boom (4) mounted thereon and a dipper arm (5) pivotally coupled to a distal end of said boom to which an implement, such as a bucket, may be attached, said lifting device comprising a mast (12) upon which is slideably mounted a carriage (20), a pair of spaced tines (21, 22) being provided on said carriage for supporting a pallet thereon, wherein said mast is mounted on said dipper arm of said excavator to be arranged in a vertical or substantially vertical operative orientation such that, in use, said carriage can be moved between lowered and raised positions on said mast when the mast is mounted on said boom, wherein at least one ground engaging load bearing member (28, 29) is provided at a lower end of said mast.

### FIELD OF INVENTION

This invention relates to an excavator having a lifting device for lifting a pallet wherein said lifting device can be fitted to a standard excavator, in particular to a back hoe, in order to use the excavator as a fork lift.

### BACKGROUND OF INVENTION

The use of a variety of tool attachments for excavators such as buckets, rakes, thumbs, hammers etc. is known in the prior art. In particular it is known to provide a fork attachment in lieu of or attached a bucket of an excavator to enable the excavator to lift palletised objects (for example see GB 1,373,646). However, excavator manufacturers publish tables detailing the lift capacities of their excavators when using attachments mounted at the end of the dipper arm. A disadvantage of using an excavator in lift activities is that the attachment path is severely limited to an arc centred on the dipper hinge, and when the attachment is lifted it moves away from the machine, increasing the radius and decreasing the safe load that may exceed the recommended limits, increasing the risk of instability and overturning of the excavator.

It is therefore an object of the present invention to advance the technology for excavator arm attachments in order to make the swapping between excavator/lift activities more efficient, to increase the safe range of lift capacities for excavators and to introduce a new means of adapting an existing excavator to make it suitable for fork lift activities.

### SUMMARY OF INVENTION

According to a first aspect of the invention, there is provided an excavator having a lifting device for lifting a pallet comprising a chassis having a boom mounted thereon and a dipper arm pivotally coupled to a distal end of said boom to which an implement, such as a bucket, may be attached, said lifting device comprising a mast upon which is slideably mounted a carriage, a pair of spaced tines being provided on said carriage for supporting a pallet thereon, wherein said mast is mounted on said dipper arm of said excavator to be arranged in a vertical or substantially vertical operative orientation such that, in use, said carriage can be moved between lowered and raised positions on said mast when the mast is mounted on said boom, wherein at least one ground engaging load bearing member is provided at a lower end of said mast.

A linkage preferably extends between a lower end of the mast of the lifting device and the chassis of the excavator for facilitating maintenance of the mast of the lifting device in a vertical orientation. Preferably said linkage is adjustable in length. The linkage may comprise at least one double acting ram.

In a preferred embodiment the mast of the lifting device is arranged parallel to or substantially parallel to the dipper arm.

Preferably the mast of the lifting device is releasably mounted on the dipper arm of the excavator to permit removal of the lifting device when not required and to allow the lifting device to be retro-fitted to an existing excavator. The mast may be releasably coupled to the dipper arm at an upper end thereof and to a quick hitch coupler mounted on the dipper arm at a lower end of the mast or to a lower end of the mast adjacent thereto. The mast, at an upper end thereof, may be releasably coupled to a pivot pin providing pivotal connection between the boom and dipper arm.

In one embodiment said at least one ground engaging load bearing member of the lifting device may comprise at least one wheel. Preferably said at least one wheel has an axis of rotation extending transverse to the mast.

In one embodiment said at least one ground engaging load bearing member may comprise a beam extending transverse to the mast and having a respective ground engaging wheel mounted at or adjacent either end thereof. The beam may be coupled to the mast via an articulated coupling permitting the beam to tilt with respect to a vertical axis of the mast to accommodate uneven ground. The articulated coupling may comprise a pivot having an axis extending perpendicular to the mast.

Preferably the lifting device includes a drive means for moving the carriage between its lowered and raised positions. The drive means may comprise a ram mounted on said mast. The drive means may be coupled to the carriage via one or more cables or chains extending over one or more fixed and/or movable pulleys.

### BRIEF DESCRIPTION OF DRAWINGS

An embodiment of the present invention will now be described with reference to the accompanying drawings, in which:

FIG. 1 is a side view of an excavator and lifting device in accordance with a first embodiment of the present invention;

FIGS. 2 is a front view of the lifting device of the excavator of FIG. 1;

FIG. 3 is a side view of the lifting device of the excavator of FIG. 1; and

FIG. 4 is an exploded view of the lifting device of the excavator of FIG. 1.

### DETAILED DESCRIPTION OF DRAWINGS

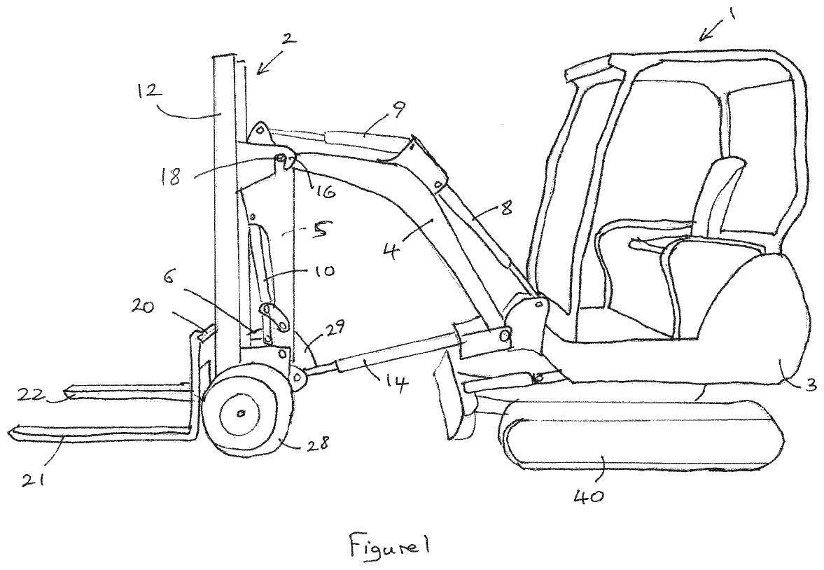

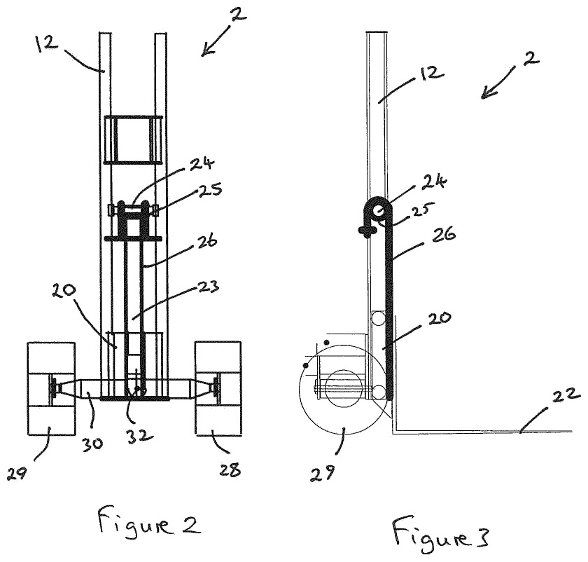

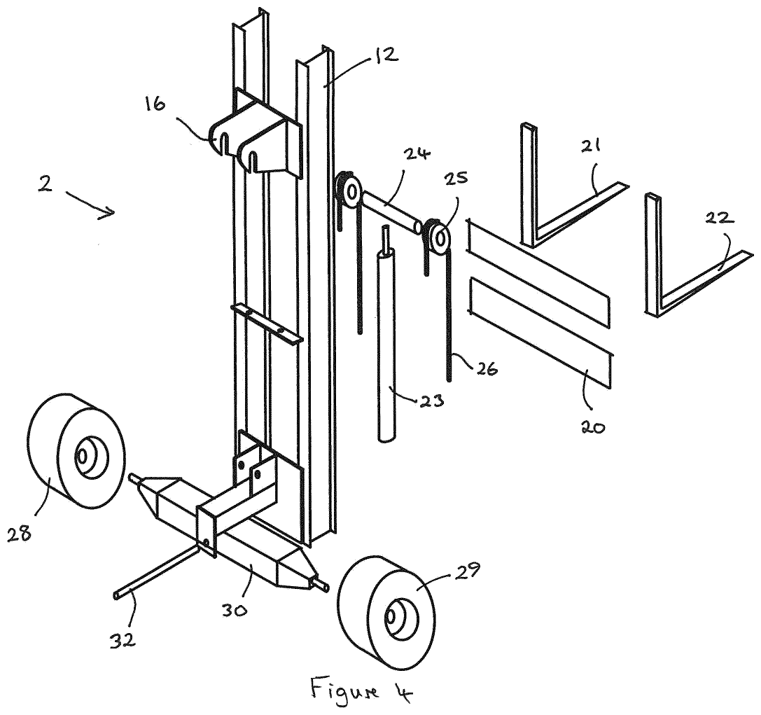

Referring now to FIG. 1 of the accompanying drawings, there is illustrated an excavator 1 having a fork lift type lifting device 2 in accordance with an embodiment of the present invention. The lifting device 2 is adapted to allow a standard excavator 1 to be transformed into a fork lift in order to lift a palletised load. The term excavator is understood to cover a vehicle of item of construction equipment which comprises a chassis 3 having a boom 4 mounted thereon and a dipper arm 5 pivotally coupled to a distal end of said boom 4, a quick coupler 6 being provided at a distal end of the dipper arm 5 to which an implement, such as a bucket, may be attached. The boom 4 and dipper arm 5 may be articulated to operate the implement attached to the quick coupler 6 via a series of double acting rams 8,9,10 mounted to operate between the chassis 3 and boom 4, between the boom 4 and dipper arm 5 and between the quick coupler 6 and dipper arm 5, as is conventional in the art.

The lifting device 2 comprises a mast 12 which is designed to be releasably coupled to and supported on a front face of the dipper arm 5 of the excavator 1, such that the mast 12 is supported in a vertical orientation on the excavator 1 with the dipper arm 5 arranged as shown in FIG. 1. An adjustable length linkage 14, preferably in the form of a double acting ram, extends rearwardly from a rear side of the mast 12 and is coupled to the chassis 3 of the excavator 1 to align and maintain the mast 12 in a vertical orientation.

As illustrated in FIGS. 1 and 4, the mast 12 may be coupled to the dipper arm 5 of the excavator 1 at an upper end by means of hooks 16 engaged over laterally extending pins 18 provided on the dipper arm 5. These pins may comprise part of a pivot pin 18 providing pivotal coupling between the boom 4 and dipper arm 5. Latch members (not shown) may be provided for locking the pins 18 within the hooks 16. A lower end the mast 12 is coupled to the dipper arm via a suitable coupling device, such as a locking pin extending through cooperating apertures in the mast 12 and dipper arm 5 or via suitable hooks and pins similar to those provided at the upper end of the mast 12 and dipper arm 5. In one embodiment the lower end of the mast 12 may be coupled to the pivot pin provided between the dipper arm 5 and quick coupler 6. Alternatively, the lower end of the mast may be coupled to the quick coupler 6 itself.

A carriage 20 is slideably mounted on the mast 12, a pair of laterally extending tines or forks 21,22 extending from the carriage 20 for supporting a pallet thereon. Rollers of similar couplings (not shown) may be provided on the carriage engaged with channels or similar cooperating means on the mast 12 to constrain the carriage 20 to movement between raised and lowered positions on the vertically arranged mast 12.

A ram 23 may be mounted on the mast 12 and may be coupled to the carriage 20 to move the carriage 20 between its raised and lowered positions on the mast 12. The ram 23 may act against one end of one or more cables 26 coupled to the carriage 20, said cables passing over guide pulleys 25. Alternatively the ram 23 may act against an intermediate member 24 incorporating the guide pulleys 25, the cables 26 extending between the mast 12 and the carriage 20 and extending over the pulleys 25, whereby extension of the ram 23 causes the intermediate member 24 to be raised with respect to the mast 10 and, via the pulleys 25 and cables 26, causing the carriage 20 to be raised, thereby magnifying the motion of the ram 23, thereby increasing the range of movement of the carriage 20.

The tines 21,22 are preferably arranged substantially parallel to the ground. Rough terrain forks need to be able to slide into a pallet on uneven ground, and thus the tines 21,22 may be mounted to permit upward displacement or tilting of the tines, as is known in the art.

In order to greatly increase the load handling capability of the excavator 1 when using the lifting device 2 at least one ground engaging load bearing member is provided at a lower end of said mast of the lifting device adapted to engage the ground and support at least part of the weight of the lifting device and the load applied thereto, in use.

In the embodiment shown in the drawings the at least one ground engaging load bearing member comprises a pair of wheels 28,29 arranged to allow the excavator 1 and lifting device 2 to be moved forwards and backwards to facilitate engagement of the tines 21,22 with a pallet upon which a load is supported and to facilitate movement of the load once carried by the tines 21,22.

In the embodiment shown in the drawings, the wheels 28,29 are mounted at either end of a beam 30 pivotally coupled to a lower end of the mast 12 via a pivot pin 32 extending horizontally and perpendicular to the mast 12 such that the beam 30 can tilt with respect to a vertical axis of the mast 12 to accommodate uneven ground while maintaining the mast 12 in a vertical orientation.

In use, the lifting device 2 can be readily coupled to the dipper arm 5 of an excavator 1 when it is desired to use the excavator to handle palletised loads. The linkage/ram 14 and boom 4 of the excavator 1 can be initially manipulated to raise the dipper arm 5 and the attached lifting device 2 such that the wheels 28,29 of the lifting device 2 are raised from the ground, permitting the excavator 1 to be readily manoeuvred into position adjacent a palletised load to be handled.

Once in position, the linkage/ram 14, boom 4 and dipper arm 5 of the excavator 1 can be manipulated such that the wheels 28,29 of the lifting device engage the ground, with the mast 12 arranged in a vertical orientation, and the excavator can be advanced to bring the tines 21,22 into engagement with a pallet. Once in position, the ram 23 of the lifting device 2 can be operated to raise the carriage and lift the pallet, along with the load provided thereon. During such operation, at least a portion of the weight of the load is transferred to the wheels 28,29 of the lifting device 2, and thereby the ground, such that the load is not wholly supported by the boom 4. This greatly increases the lifting capacity of the lifting device 2 compared to the use of the boom 4 and dipper arm 5 alone.

The excavator 1 can then be manoeuvred to carry the load to a desired location before the carriage can be lowered to place the pallet carried thereon onto the ground of any other desired location. The articulation of the beam 30 on the mast 2 allows the excavator 2 and lifting device 2 to traverse uneven ground without placing excessive load on the beam 30.

Should it be desired to steer the excavator 1 during such load handling operation, the tracks 40 of the excavator can be rotated so that the excavator 1 can be moved laterally about a centre defined by the mast 12, avoiding the need for the wheels 28,29 to be steered. Alternatively it is envisaged that the wheels 28,29 may be adapted to be steerable.

1. An excavator having a lifting device for lifting a pallet comprising a chassis having a boom mounted thereon and a dipper arm pivotally coupled to a distal end of said boom to which an implement, such as a bucket, may be attached, said lifting device comprising a mast upon which is slideably mounted a carriage, a pair of spaced tines being provided on said carriage for supporting a pallet thereon, wherein said mast is mounted on said dipper arm of said excavator to be arranged in a vertical or substantially vertical operative orientation such that, in use, said carriage can be moved between lowered and raised positions on said mast when said mast is mounted on said boom, wherein at least one ground engaging load bearing member is provided at a lower end of said mast.

2. The excavator of claim 1, wherein a linkage extends between a lower end of said mast of said lifting device and said chassis of said excavator.

3. The excavator of claim 2, wherein said linkage is adjustable in length.

4. The excavator of claim 3, wherein said linkage comprises at least one double acting ram.

5. The excavator of claim 1, wherein said mast of said lifting device is arranged parallel to or substantially parallel to the dipper arm.

6. The excavator of claim 1, wherein said mast of the lifting device is releasably mounted on the dipper arm of the excavator.

7. The excavator of claim 6, wherein said mast is releasably coupled to said dipper arm at an upper end thereof and to a quick hitch coupler mounted on said dipper arm at a lower end of said mast.

8. The excavator of claim 6, wherein said mast, at an upper end thereof, is releasably coupled to a pivot pin providing pivotal connection between said boom and said dipper arm.

9. The excavator of claim 1, wherein said at least one ground engaging load bearing member of said lifting device comprises at least one wheel.

10. The excavator of claim 9, wherein said at least one wheel has an axis of rotation extending transverse to said mast.

11. The excavator of claim 10, wherein said at least one ground engaging load bearing member comprises a beam extending transverse to said mast and having a respective ground engaging wheel mounted at or adjacent either end thereof.

12. The excavator of claim 11, wherein said beam is coupled to said mast via an articulated coupling permitting said beam to tilt with respect to a vertical axis of said mast to accommodate uneven ground.

13. The excavator of claim 12, wherein said articulated coupling comprises a pivot having an axis extending perpendicular to said mast.

14. The excavator of claim 1, wherein said lifting device includes a drive means for moving said carriage between its lowered and raised positions.

15. The excavator of claim 14, wherein said drive means comprises a ram mounted on said mast

16. The excavator of claim 14, wherein said drive means is coupled to said carriage via one or more cables or chains extending over one or more fixed and/or movable pulleys.
